(19) United States
(12) Patent Application Publication
(10) Pub. No.: US 2007/0025181 A1
(43) Pub. Date: Feb. 1, 2007

(54) Device for connecting a tubule to a mixer

(75) Inventor: Wilhelm A. Keller, Merlischachen (CH)

Correspondence Address: FOLEY AND LARDNER LLP;SUITE 500, 3000 K STREET NW, WASHINGTON, DC, 20007, US

(73) Assignee: Mixpac Systems AG

(21) Appl. No.: 10/558,761

(22) PCT Filed: May 26, 2004
(86) PCT No.: PCT/CH04/00318

§ 371 Date: Dec. 1, 2005

(30) Foreign Application Priority Data
Jun. 3, 2003 (CH) 979/03

(51) Int. Cl. B01F 15/02

(52) U.S. Cl. 366/184

(57) ABSTRACT

The coupling for connecting a tube (2) to a commercially available mixer or mixer accessory comprises an adapter (3) and a fastening piece (4), the adapter being provided at one end with an insertion portion (8) and at the other end with a receiving portion (12), and the fastening piece being pushed over the adapter. A coupling of this type allows the secure and simple use of capillary tubes, e.g. for medical technique.

The present invention refers to a coupling for connecting a capillary tube to a mixer or a mixer accessory.

For certain applications, mainly in the dental or medical fields, it is often necessary to connect a fine tube, also called capillary tube, in order to be able to apply the mixed composition punctually also at difficultly accessible locations.

EP-A-0 091 773 discloses a coupling for a pressure hose in compressed air control systems where the hose is slotted and is under the action of a clamp. Such an arrangement is not suitable for dental or medical technique.

EP-A-0 368 377 discloses an implantable injection chamber where the chamber is provided with a tube in which a catheter is inserted that is subsequently fastened by means of a clamping ring.

U.S. Pat. No. 4,013,310 relates to a coupling for connecting a tube to a connecting device, the tube being inserted in a flexible, slotted outlet portion of the device and secured by a slidable collet ring.

U.S. Pat. No. 4,690,306 relates to a coupling between an outlet portion and a mixer that is secured by means of a screw cap, however.

U.S. Pat. No. 4,771,919 discloses an attachment of a mixer to a cartridge by means of an adjustable coupling ring.

U.S. Pat. No. 3,971,576 refers to a hose coupling for pneumatic circuits.

On the background of this prior art, it is an object of the present invention to provide a tight coupling of a capillary tube for connection to a mixer or a mixer accessory, which is applicable for dental and medical technique, allows an inexpensive manufacture using commercially available mixers, and is simple to use. This is accomplished by a coupling as described in claim 1.

The invention will be explained in more detail hereinafter with reference to drawings of an exemplary embodiment.

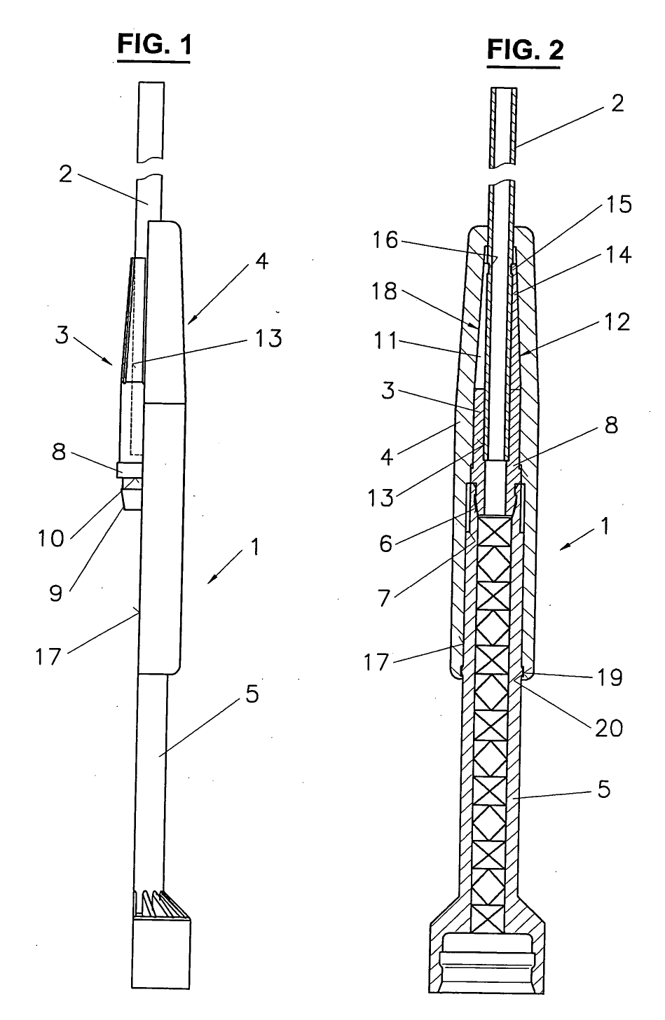

FIG. 1 shows an exemplary embodiment in a cutaway lateral view, and

FIG. 2 shows the exemplary embodiment of FIG. 1 in a longitudinal section.

FIG. 1 illustrates a part of a mixer 1 and a capillary tube 2 for connection thereto, the latter being made of a rigid material, e.g. of metal, or of a resilient material, e.g. of a plastics material, as well as an adapter 3 and a fastening piece 4. Essentially, only mixer housing 5 of the mixer is shown. The mixer resp. the mixer housing is conventional and has been on the market for some time now. In this context, it is of particular interest that an internal groove 6 and an external shoulder 7 are provided on the mixer outlet end.

Adapter 3 has an insertion end 8 that is pushed into the mixer outlet and is provided with a conical end portion 9 with a shoulder 10, while a conical retaining portion 12 provided with slots 11 is arranged at the other end. Slots 11 define retaining fins 14. Bore 13 in the retaining portion, which corresponds to the external diameter of the capillary tube, extends into the insertion end of the adapter.

At least one of retaining fins 14 is provided near its end with an inwardly directed nose 15 that engages in a corresponding notch or annular groove 16 of the capillary tube to retain it. This is generally the case if the capillary tube is of metal. If the capillary tube is made of a resilient material, the nose will impress itself into the material of the capillary tube and thereby retain it.

Another component is fastening piece 4, the inside of which is composed of a cylindrical portion 17 and a conical portion 18 that tapers toward the end. It is further apparent that the mixer side end of fastening piece 4 is provided with an internal circular groove 20 allowing a corresponding external bead or projections 19 of the mixer end to snap in or to be snapped in. Other snap-action elements such as noses and notches may also be used.

Before securing a tube or capillary tube, the adapter is pushed into the mixer outlet as far as possible until shoulder 9 engages behind internal groove 6 on the mixer, snaps in, and retains the adapter.

Then the capillary tube is pushed into the adapter as far as possible and fastening piece 4 is pushed home, thereby compressing the retaining fins of the adapter and providing a secure retention of the capillary tube.

Within the scope of this embodiment, it is also conceivable to use a different fastening piece, e.g. one having a screw thread, to achieve a better retention on the mixer housing or, similarly to the notch or the circular groove on the capillary tube, to provide such a notch or another retaining element on the mixer and at one end of the fastening piece. It is also possible to secure the fastening piece to the mixer by cementing.

In a further exemplary embodiment, instead of using a separate retaining portion, the retaining fins are directly injection-molded on the mixer outlet or separately produced and securely connected thereto. This solution allows simplifying the entire attachment of a capillary tube. The fastening piece is the same as previously described or has an analogous configuration and the same function.

1. A coupling for connecting a capillary tube to a mixer or mixer accessory, comprising an adapter and a fastening piece, the adapter being provided at one end with an insertion portion and at the other end with a retaining portion.

2. A coupling according to claim 1, wherein the insertion portion of the adapter, which is intended for being pushed into a mixer outlet, has a conical end with a shoulder, and the retaining portion of the adapter, which is intended for receiving the tube, comprises retaining elements.

3. A mixer or mixer accessory and capillary tube for connection thereto, wherein the mixer outlet is provided with retaining elements for the capillary tube and a fastening piece that can be pushed onto the mixer outlet is provided.

4. A coupling according to claim 1, wherein the fastening piece comprises an internally cylindrical portion at a mixer end and an internally conical portion at the other end.

5. A coupling according to claim 2, wherein the retaining elements are retaining fins and at least one of the retaining fins comprises a nose.

6. A coupling according to claim 5, wherein the tube is of a rigid material and is provided with a notch or annular groove that corresponds to the nose on the retaining fin.

7. A coupling according to claim 4, wherein the cylindrical portion of the fastening piece is provided with an internal groove that cooperates with an internal bead or with projections on the mixer.
